(19) United States
(12) Patent Application Publication
(10) Pub. No.: US 2005/0267719 A1
(43) Pub. Date: Dec. 1, 2005

(54) Field synthesis system and method for optimizing drilling operations

(76) Inventor: Hubert Foucault, Bordeaux (FR)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/106,966

(22) Filed: Apr. 15, 2005

(30) Foreign Application Priority Data
Apr. 19, 2004 (GB) 04 086 97.1

(51) Int. Cl. G06G 7/48

(52) U.S. Cl. 703/10

(57) ABSTRACT

A system and method for optimizing the performance of a drilling device utilizes well logs and drilling parameters from multiple offset wells located in proximity to the location of a desired wellbore. The well logs and drilling parameters data from the offset wells is synthesized to determine major drilling contexts including both geological trends, mechanical properties and the different well profiles. The performance of one or more drilling devices and or drilling parameters is then simulated within the selected drilling contexts of the offset wells. The simulation information is then used to select an optimized drilling device or parameter for drilling the selected wellbore.

### FOREIGN PRIORITY

This application claims foreign priority to British Application Patent Number 04 086 97.1 filed Apr. 19, 2004.

### TECHNICAL FIELD OF THE INVENTION

The present invention relates in general to systems, methods and techniques for drilling wellbores and more specifically to a field synthesis system and method for optimizing drilling operations.

### BACKGROUND OF THE INVENTION

One significant challenge faced in the drilling of oil and gas wells is predicting the future drilling performance of a drilling system. There are a number of downhole conditions and/or occurrences which can be of great importance in determining how to proceed with an operation, including selecting drilling devices and operating parameters that will be used in a particular drilling operation.

In many situations multiple wells are drilled within a single field. When drilling a new wellbore within such a field, log data from a nearby “offset” well data is often used to select the drilling equipment and drilling parameter that will be used to drill the new wellbore. This typically involves comparing the performance of drilling devices (typically in terms of average rate of penetration (ROP)) that were used to drill the offset wells. Over the course of the development of the field, drilling device selection and drilling parameter selection gradually improves. This gradual improvement, sometimes referred to as a “learning curve”, is typically slower than desired often requiring drilling ten or more wells to identify optimal drilling devices and drilling parameters. Additionally, the use of overall drilling performance in offset wells may provide spurious inferences where a field has significant lithology, mechanical property, and thickness variations. In such situations, the use of data from an offset well is often an inaccurate indicator of whether a particular drilling device was the best selection for drilling a particular wellbore.

Accordingly, such information is often of limited value in predicting how a particular drilling device or how particular drilling equipment will perform in fields with significant variations in lithology and mechanical properties. Such use of offset well data in fields with variations in lithology often results in the selection of drilling devices and drilling parameters that are not optimized. Such non-optimized selections result in increased drilling times and increased cost.

### SUMMARY OF THE INVENTION

Therefore, a need has arisen for a method and system for optimizing drilling device performance in fields with significant variations in lithology or mechanical properties.

A further need exists for a method and system for optimizing drilling parameters for wells drilled in fields with significant variations in lithology or mechanical properties. In accordance with teachings of the present disclosure, a system and method are described for optimizing the performance of a drilling device that reduces or eliminates many of the problems associated with previously developed methods and systems. The disclosed system and method for optimizing the performance of a drilling device utilizes well logs and drilling parameters from multiple offset wells located in proximity to the location of a desired wellbore. The logs from the offset wells are synthesized to determine major drilling contexts including both geological trends, mechanical properties and the different well profiles. The predicted lithology and well profile of the selected wellbore are then divided into multiple drilling contexts. The performance of one or more drilling devices and or drilling parameters is then simulated within the selected drilling contexts of the offset wells. Offset drilling contexts and predicted drilling contexts are then compared. The simulation information is then used to select an optimized drilling device or parameter for drilling the selected wellbore.

Additionally, the simulation data can be used to modify the design of the drilling device and to optimize its performance while drilling the selected wellbore. Such real time optimization provides significant advantages over previous techniques. Such real time optimization includes evaluating drilling contexts and actual drilling contexts using MWD or LWD in real time. In this manner, offset drilling contexts as well as drilling device and drilling parameters may be analyzed and selectively modified during the drilling of the selected wellbore.

In one aspect a method is disclosed that optimizes the performance of a drilling device for drilling a selected wellbore. The method includes obtaining well logs from three or more offset wells that are associated with the selected wellbore. The well logs from the offset wells are then synthesized. The synthesized well log data is then evaluated within multiple drilling contexts. Finally the performance of the drilling device is simulated in one or more of the drilling contexts of the offset wells. In a particular embodiment the performance of a first drill bit and a second (or more) drill bit are simulated and the results of the simulation are then compared against one another to determine the drill bit that will achieve optimum performance for a new wellbore.

In another aspect a method is disclosed for optimizing one or more drilling parameters that are used to drill a selected wellbore using a selected drilling device. The method includes obtaining well logs from three or more offset wells that are associated with the selected wellbore. The well logs are then synthesized and divided into multiple drilling contexts. A drilling context is then selected for predicting drilling performance in a new well. Simulations are then performed of the drilling device using a first set of drilling parameters and using a second (or more) set of drilling parameters within the select drilling context. The predicted performances are then compared to determine the optimum parameters for drilling the desired well.

In another aspect, a system for optimizing the performance of a drilling device for drilling a selected well bore includes a well log analysis module having mechanical properties evaluation capabilities, a field synthesis module, a context analysis module, and a drilling simulation module. The well log analysis module receives well logs from three or more offset wells located in proximity to the selected well bore. The field synthesis module then synthesizes the well logs from the at least three offset wells. The drilling context analysis module acts to divide the predicted lithology and well profile of the selected well bore into multiple drilling contexts. The simulation module then simulates the performance of a selected drilling device or drilling parameter in the selected drilling contexts of the offset wells.

The present disclosure includes a number of important technical advantages. One important technical advantage is synthesizing well logs from three or more offset wells. This allows for the determination of which drilling context are key in the optimization of a drilling device or drilling parameters, especially in fields that have significant variation in lithology and mechanical properties. Another important technical advantage is separating the predicted lithology and well profile of the selected wellbore that is to be drilled into multiple drilling contexts. This allows for a detailed analysis to occur within drilling contexts that are likely to be critical to the overall drilling performance of the selected wellbore. Additional advantages of the present invention will be apparent to those of skill in the art in the FIGURES description and claims herein.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a drilling system according to teachings of the present disclosure;

FIG. 2 is a diagram showing the locations of multiple wells within a single field;

FIG. 3 is a table showing drilling information and formation and mechanical properties information related to multiple wells drilled within a single field;

FIG. 4 is a graph showing variations in drilling conditions for different wells in a single field for identifying and analyzing drilling contexts according to teachings of the present disclosure;

FIG. 5 shows a flow diagram of a method for simulating drilling performance using synthesized offset well data;

FIG. 6 is a flow diagram showing a method for optimizing drilling performance according to the present disclosure;

FIG. 7 shows the performance of multiple different drill bits for drilling operations within a selected drilling context;

FIG. 8 shows the variation in drilling parameters used to drill a series of wellbores in a field within a selected drilling context;

FIG. 9 shows the performance of three drill bits in a second selected drilling context within a field;

FIG. 10 shows a performance analysis for multiple wells using teachings of the present disclosure in a selected critical drilling context; and

FIG. 11 is a diagram of a system for optimizing the performance of a drilling device according to teachings of the present disclosure.

### DETAILED DESCRIPTION OF THE INVENTION

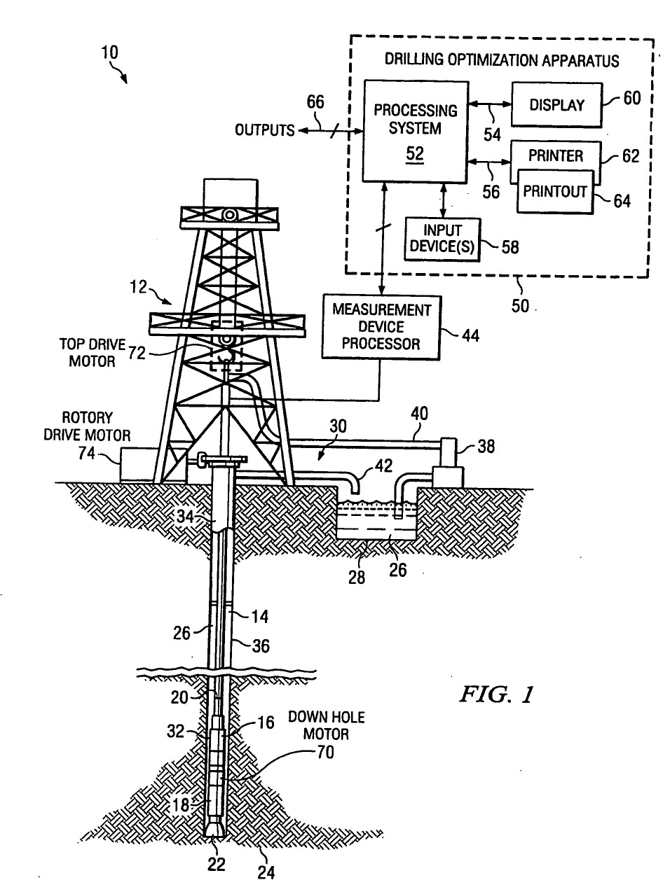

Preferred embodiments and their advantages are best understood by reference to FIGS. 1-10 wherein like numbers are used to indicate like and corresponding parts.

Now referring to FIG. 1, a drilling system depicted generally at 10 includes a drilling rig 12 disposed atop a borehole 14. A logging tool 16 is carried by a sub 18, typically a drill collar, incorporated into a drill string 20 and disposed within the borehole 14. A drill bit 22 is located at the lower end of the drill string 20 and carves a borehole through earth formations 24. Drilling mud 26 is pumped from a storage reservoir pit 28 near the wellhead 30, down an axial passageway (not expressly shown) through the drill string 20, out of apertures in drill bit 22 and back to the surface through annular region 32. Metal casing 34 is positioned in borehole 14 above drill bit 22 for maintaining the integrity of an upper portion of borehole 14. Drilling system 10 also includes equipment such as downhole motor 70, top drive motor 72 and rotary table motor 74 to provide power to the system.

Annular region 32 is located between drill string 20, sub 18 and sidewalls 36 of borehole 14 and forms the return flow path for the drilling mud. Mud is pumped from storage pit 28 near wellhead 30 by pumping system 38. Mud travels through mud supply line 40 which is coupled to a central passageway extending throughout the length of drill string 20. Drilling mud is pumped down drill string 20 and exits into borehole 14 through apertures in drill bit 22 that act to cool and lubricate the bit and carry formation cuttings produced during the drilling operation back to the surface. Fluid exhaust conduit 42 connects with annular passageway 32 at the wellhead for conducting the return flow of the mud from borehole 14 to mud pit 28. Drilling mud is typically handled and treated by various apparatus (not expressly shown) such as outgassing units and circulation tanks for maintaining a preselected mud viscosity and consistency.

Logging tool or instrument 16 can be any conventional logging instrument such as acoustic (sometimes referred to as sonic), neutron, gamma ray, density, photoelectric, nuclear magnetic resonance, or any other conventional logging instrument, or combinations thereof which can be used to measure the lithology or porosity of formations surrounding an earth borehole.

Because the logging instrument is embedded in the drill string 20 the system is considered to be a measurement while drilling (MWD) system that logs while the drilling process is underway. The logging data can be stored in a conventional downhole recorder which can be accessed at the surface when drill string 20 is retrieved, or it can be transmitted to the surface using telemetry such as conventional mud pulse telemetry systems. In either case logging data from logging instrument 16 is provided to processor 44 to be processed for use in accordance with the embodiments of the present disclosure as provided herein.

In alternate embodiments wire line logging instrumentation may also be used in addition to the MWD instrumentation described above. Typically with wire line instrumentation, a wire line truck (not shown) is typically situated at the surface of the wellbore. A wire line logging instrument is suspended in the borehole by a logging cable which passes over a pulley and a depth measurement sleeve. As the logging instrument traverses the borehole it logs the formation surrounding the borehole as a function of depth. Logging data is then transmitted through the logging cable to a processor (such as processor 44) located at or near the logging truck to process the logging data as appropriate for use with the instruments of the present disclosure. As with MWD systems, the wire line instrumentation may include any conventional logging instrumentation which can be used to measure the lithology and/or porosity of formations surrounding an earth borehole, such as: acoustic, neutron, gamma ray, density, photoelectric, nuclear magnetic resonance, or any other conventional logging instrument or accommodations thereof which can be used to measure the lithology.

In the present embodiment, apparatus 50 preferably optimizes the performance of drilling system 10 for drilling a selected wellbore in a given formation 24 is shown. In the present preferred embodiment, drilling prediction system 50 is remotely located with respect to drilling rig 12. Data from drilling rig 12 and other offset wells may be transmitted to system 50 via a network connection or may be physically uploaded via a storage medium such as a diskette, CD-ROM or the like.

Prediction apparatus 50 may include any suitable geology and drilling mechanics simulation models and further includes optimization and prediction modes of operation discussed further herein. Prediction apparatus 50 further includes a device 52 (which will be referred to herein as a “processing system”) that may include any suitable commercially available computer, controller, or data processing apparatus, further being programmed for carrying out the method and apparatus as further described herein.

In a preferred embodiment, the offset well log data received by processing system that is associated with borehole 14 and other offset well data may include, for example well logs that incorporate caliper, Gamma Ray, Spectral Gamma Ray, Resistivitiy, Spontaneous Potential, Sonic, Neutron and Density, Photoelectric, and NMR data. Well log data may further include survey-deviation, UTM coordinates, and information from mud logs including geologic and formation tops information. The offset well log data may further include drilling data such as: bit performance data, bit Records, and drilling parameters such as rate of penetration (ROP), weight on bit (WOB), revolutions per minute (RPM), torque, flow rate. Drilling data may also include stand pipe pressure, gas, and mud weight

Processing system 52 includes at least one input for receiving input information (for instance, such as well log data as described above) and/or commands from any suitable input device, or devices 58. Input device 58 may include a keyboard, keypad, pointing device or the like. Input device 58 may further included a network interface or other communications interface for receiving input information from a remote computer or database. Input devices may be used for inputting specifications of proposed drilling equipment or drilling parameters for used in a simulation of drilling a new wellbore.

Processing system 52 also includes at least one output 66 for outputting information signals. In the present embodiment, output signals can also be output to a display device 60 via communication line 54 for use in generating a display of information contained in the output signals. Output signals can also be output to a printer device 62, via communication line 56, for use in generating a print-out 64 of information contained in the output signals.

Processing system 52 is preferably programmed to perform the functions as described herein using program techniques known to those skilled in the art. In a preferred embodiment processing system 52 preferably includes a computer readable medium having executable instructions stored thereon for carrying out the steps described herein. Processing system may incorporate a commercial computing platform such as Openworks and Insite offered by Halliburton or another suitable computing platform. In some embodiments, processing system may incorporate different modules for carrying out the different steps or processes described in FIG. 11, herein.

In the present embodiment, processing system 52 operates to synthesize well logs from multiple offset wells. The drilling performance of the selected wellbore are synthesized by first collecting data from offset wells. The data is preferably selected in order to be significant for the next field development. Next the lithology, porosity, mechanical properties are evaluated. Next, multiwell statistical studies are conducted in order to determine the geological field trends. The field trends may include variations of lithology, mechanical properties, thickness, depth of formation, and dips in function of the well location. The statistical studies may include, for instance: averages, histograms for dispersion evaluation, cross sections, cross plots graphs to study the correlation between a set of parameters, and mappings. Such field synthesis is akin to the field synthesis process is commonly applied to reservoir evaluation. However such evaluation has heretofore been limited to the analysis of petrophysical properties such as saturation, porosity, and permeability. In contrast, the field synthesis directed by processing system 52 analyzes offset well data using formation and drilling data, characteristics, and parameters likely to be critical in terms of drilling performance. In preferred embodiments bit performances are analyzed as a function of the detailed formation properties and as a function of the physical properties of the well such as diameter, deviation and direction, often referred to as the “well profile.”

The synthesized field data preferably factors in the variations in lithology and formation thickness that can be determined from the variations between the different offset wells. This is particularly advantageous in fields that have significant variations in lithology, mechanical properties and formation thickness.

Additionally, processing system 52 is operable to divide the offset well data into multiple drilling contexts. A Drilling context, for the purposes of this disclosure may include geologic contexts and well profiles. For the purposes of this disclosure, a geologic context may include any discretely defined drilling environment. For example, a geologic context may include portions of a drilling environment that have rock strength of a given interval (such as a having a rock strength between 15 Kpsi and 40 Kpsi. In other embodiments, geologic contexts may include drilling environments defined by formation type, plasticity, porosity, or abrasivity. In a one embodiment, the geologic contexts may be selectively modified by a user or operator of the system. In another embodiments, the drilling contexts may constitute standardized ranges of different drilling environments.

In this manner, processing system 52 allows a user to analyze the synthesized field data to determine whether a particular context is likely to effect drilling performance. The objective of the field synthesis process is to define and evaluate the major drilling context which will be used for the next step of the simulation and drilling optimization. Drilling contexts that are determined to have a critical influence of drilling performance may be referred to herein as a critical context.

Processing system 52 is also operable to simulate drilling of an offset well or analyze the log data using a suitable simulation model of analysis technique. For instance, processing system 52 may incorporate a lithology model as described in U.S. Pat. No. 6,044,327, issued Mar. 28, 2000, entitled “METHOD AND SYSTEM FOR QUANTIFYING THE LITHOLOGIC COMPOSITION OF FORMATIONS SURROUNDING EARTH BOREHOLES” and incorporated herein by reference. Processing system 52 may also incorporate a rock strength model as described in U.S. Pat. No. 5,767,399, issued Jun. 16, 1998, entitled “METHOD OF ASSAYING COMPRESSIVE STRENGTH OF ROCK” and incorporated herein by reference.

Additionally, Processing system 52 may also incorporate a shale plasticity model as described in U.S. Pat. No. 6,052,649, issued Apr. 18, 2000, entitled “METHOD AND SYSTEM FOR QUANTIFYING SHALE PLASTICITY FROM WELL LOGS” and incorporated herein by reference. Processing system 52 may also incorporate a mechanical efficiency model as described in U.S. Pat. No. 6,131,673, issued Oct. 17, 2000, entitled “METHOD OF ASSAYING DOWNHOLE OCCURRENCES AND CONDITIONS” and incorporated herein by reference.

For performing simulations, processing system 52 may also incorporate a bit wear model as described in U.S. Pat. No. 5,794,720, issued Aug. 18, 1998, entitled “METHOD OF ASSAYING DOWNHOLE OCCURRENCES AND CONDITIONS” and incorporated herein by reference. Processing system 52 may also incorporate a penetration rate model as described in U.S. Pat. No. 5,704,436, issued Jan. 16, 1998, entitled “METHOD OF REGULATING DRILLING CONDITIONS APPLIED TO A WELL BIT” and incorporated herein by reference.

In a preferred embodiment, after a drilling context of interest has been identified, a simulation of the drilling of the offset wells is performed using different drilling devices or drilling parameters. Subsequent simulations may then be performed by varying parameters of the drilling devices or using modified drilling parameters. For instance, in simulating the performance of a drill bit, drill bit design parameters such as number of blades, cutter type, bit profile, sharp slope, dull slope, friction slope, wear exponent, max work, initial contact area, and final contact area may be selectively adjusted and compared with the simulated performance of other drill bits.

Such simulations are preferably performed by processing system 52 for a selected drilling context. In particular preferred embodiments, this simulation may be performed for one or more drilling contexts that have been selected as a critical drilling context. As further described herein, the simulation operations performed by processing system 52 for a given series of offset wells may be performed with respect to multiple drilling devices, such as multiple drill bits. In other embodiments, the simulations performed by processing system may be performed for a selected drilling device using different drilling parameters such as different values for weight on bit (WOB) and revolutions per minute (RPM). In still other embodiments, a simulation may be performed for a selected drilling device such as a selected drill bit. The results of the simulation may then be analyzed and the attributes of the bit (such as bit profile, number of cutters, cutter size and other suitable parameters) may be modified. The performance of the modified drill bit may then be simulated and compared with the performance of the original bit.

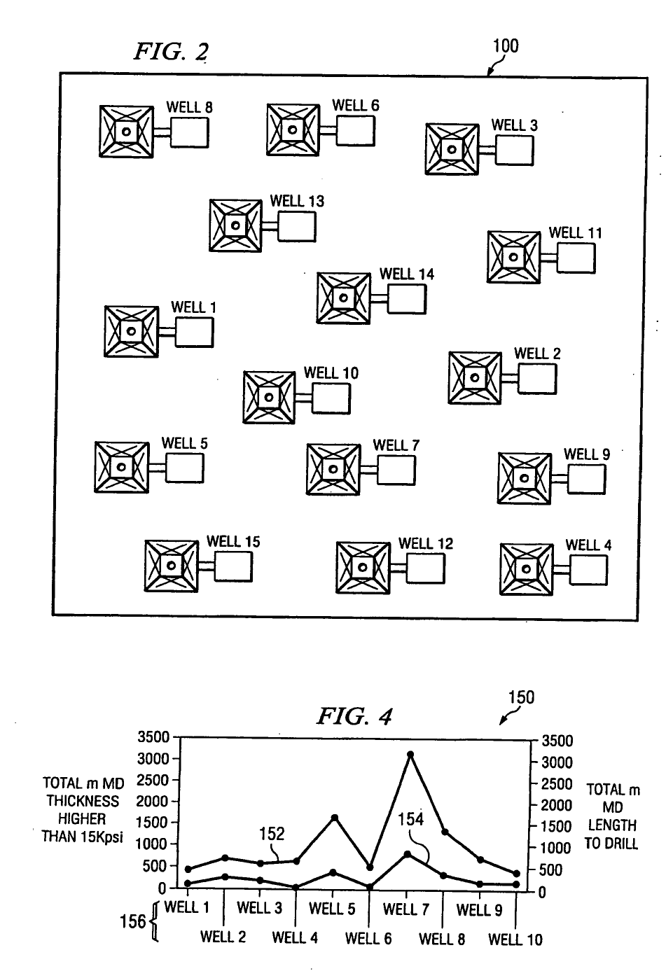

Now referring to FIG. 2, a depiction of drilling field 100 is shown. As shown, drilling field 100 includes wells 1-14 drilled within the field. In the present example embodiment, drilling field 100 contains variations in geologic formations and variations in the thickness and the mechanical properties of those formations and variations of the well profiles.

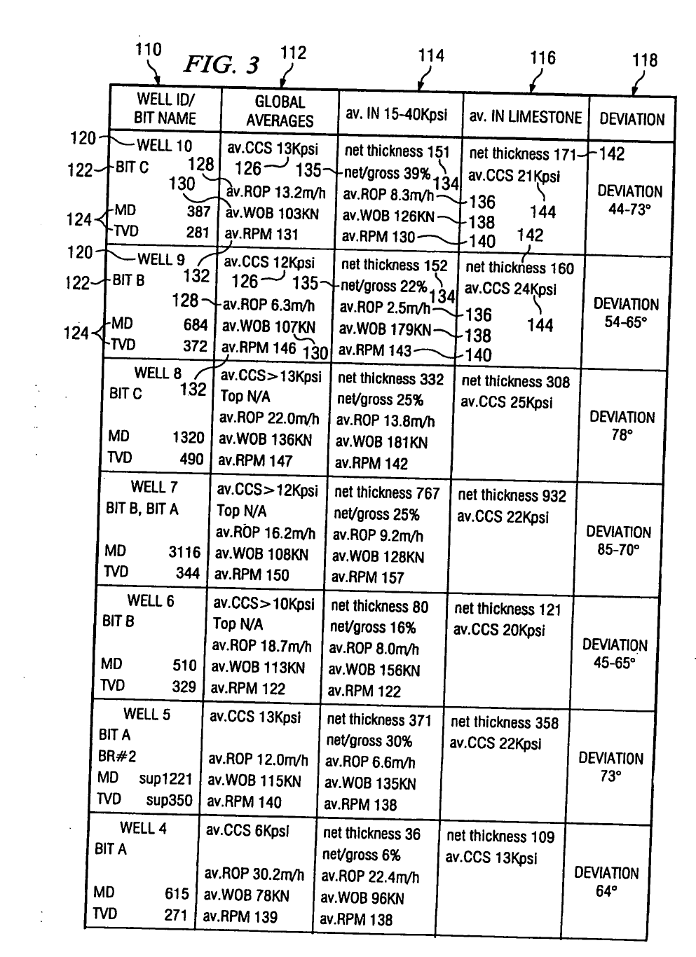

Now referring to FIG. 3, a table 105 showing geologic and drilling information related to wells 4-10 is shown. Column 110 of table lists the well identification 120, drill bit identification 122, and depth information 124 (both measured depth (MD) and true vertical depth (TVD) values). Column 112 of table 105 includes global averages for compressive rock strength 126, ROP 128, WOB 130, and RPM 132. In the present embodiment, column 114 of table 105 shows drilling information for a particular geologic context of the present well bore. For this example, the geologic context of compressive strength between 15 and 40 Kpsi was determined to be of interest. Accordingly, data for each well in the selected context is listed in column 114 including net thickness of geologic context 134, net/gross value 135, ROP 136, WOB 138, and RPM 140. Net/gross value 135 represents the ratio of the total thickness is made up of the drilling context at issue.

The table also includes data related to each well in a limestone context in column 116. Column 116 lists a net thickness value 142 and average compressive strength value for the limestone context of each well. Lastly, column 118 lists the deviation of each well. Deviation may be considered because mechanical properties commonly vary as a function of deviation. Additionally, deviation values are preferably taken into account in defining well profile as discussed above.

As shown in table 105, the thickness of the 15-40 Kpsi context and the drilling performance therein varies significantly between the wells, both in net thickness 134, and as a proportion of depth of the total well 114. FIG. 4 shows a graphical representation 150 of the total depth 152 relative to the thick in the selected geologic context (compressive strength between 15 and 40 Kpsi) 154 of the wells 156. As shown in graph 150, the absolute depths 152 as well as the thickness of the geologic context of interest 154 varies from well to well.

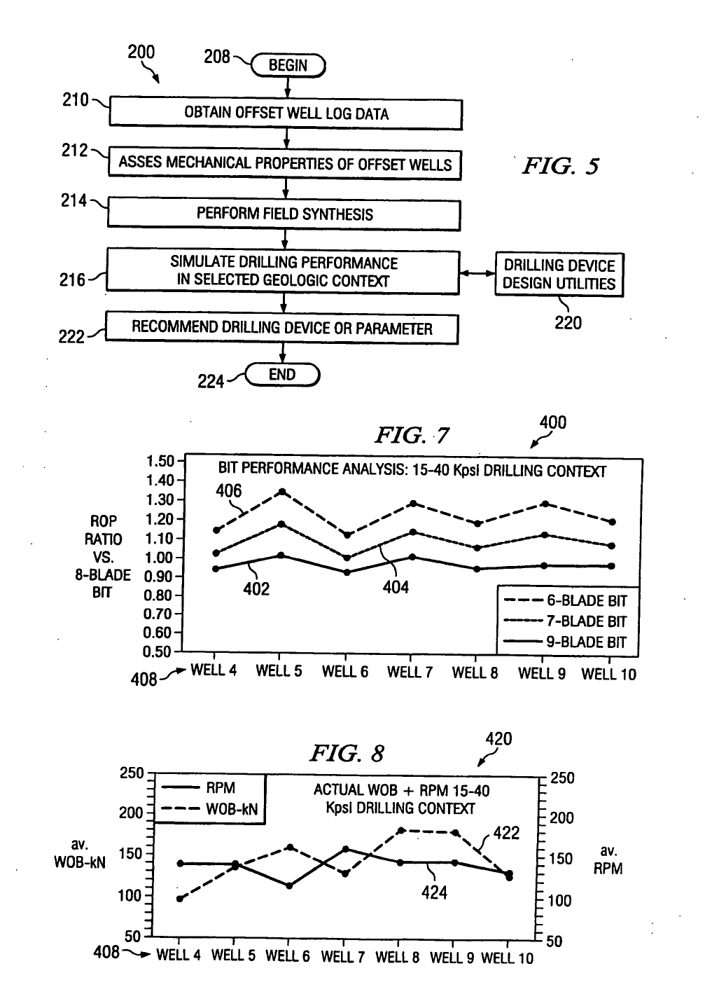

Now referring to FIG. 5, a flow diagram depicted generally at 200 shows a method according to the present invention. The method begins 208 by collecting data from offset wells 210. In the present embodiment, offset well data must be obtained for at least three offset wells that are located in proximity to the location of the new well that is desired to be drilled. In some embodiments, data from between six and twelve offset wells may be obtained and considered in the method described herein. For the purposes of this disclosure, an offset well may be considered to be any well located within the same field as the well that is desired to be drilled and whose lithology and drilling data may (in combination with information from other offset wells) be useful in the prediction of the drilling performances of the new well to be drilled.

Next the mechanical properties, in this example—rock strength, of the formations of the three or more offset wells are assessed 304. The rock strength assessment may be performed using a rock strength model as described in U.S. Pat. No. 5,767,399 or any other suitable rock strength model. Next the rock strength data from the offset wells is synthesized 306. This step may also be referred to as the field synthesis step.

The synthesized field data is then analyzed and one of more drilling contexts of interest are selected. The performance of a drilling device (or of multiple drilling devices) with one or more drilling parameters is then simulated for the select drilling context or contexts 216. In the present example embodiment, a simulation is run for the selected drilling device at specified drilling parameters for each of the individual offset wells. Simulation is limited to a simulation within the selected drilling context.

After completion of the simulation, the performance of the different drilling devices or drilling parameters is analyzed and the design of the drilling device (in this case a fixed cutter drill bit) is modified using drilling design utilities 220. In some embodiments drilling design utilities may be associated with an Application Design Engineer or another operator to facilitate the modifications to the drill bit design. The performance of the modified drilling device may then be simulated for the desired wellbore and compared with the original or unmodified drilling device. The process may be repeated until an optimized drill bit has been identified. The optimized drilling device or parameter is then recommended 222 and the method ends 224 until the desired the desired wellbore is drilled and a subsequent wellbore is desired to be drilled in the field.

In one preferred embodiment, during the drilling of the new wellbore, well logs from the new well bore may be analyzed in real time. This real time analysis may include comparing the performance of the actual performance of the drilling device with the predicted performance of the drilling device. The predicted performance of the drilling device is preferably previously determined utilizing a well prognosis of the new wellbore. The wellbore profile typically includes the expected geology of the wellbore.

As the new wellbore is drilled, the performance of the selected drilling device using the selected drilling parameter may be compared with the anticipated performance for the portion of the wellbore that has been drilled. In the event that the actual performance deviates significantly from the predicted performance, the actual drilling data may be re-synthesized with the existing offset well data to determine whether drilling device selection or drilling parameters should be modified to optimize the drilling of the well. In many cases this may involve re-evaluating the selection of the critical context for the new wellbore.

In some embodiments drilling performance simulation 216 is performed for multiple drilling devices such as multiple different drill bits. In other alternate embodiments drilling simulation step 216 is performed for a given or selected drilling device using multiple different drilling parameters such as weight-on-bit and RPM.

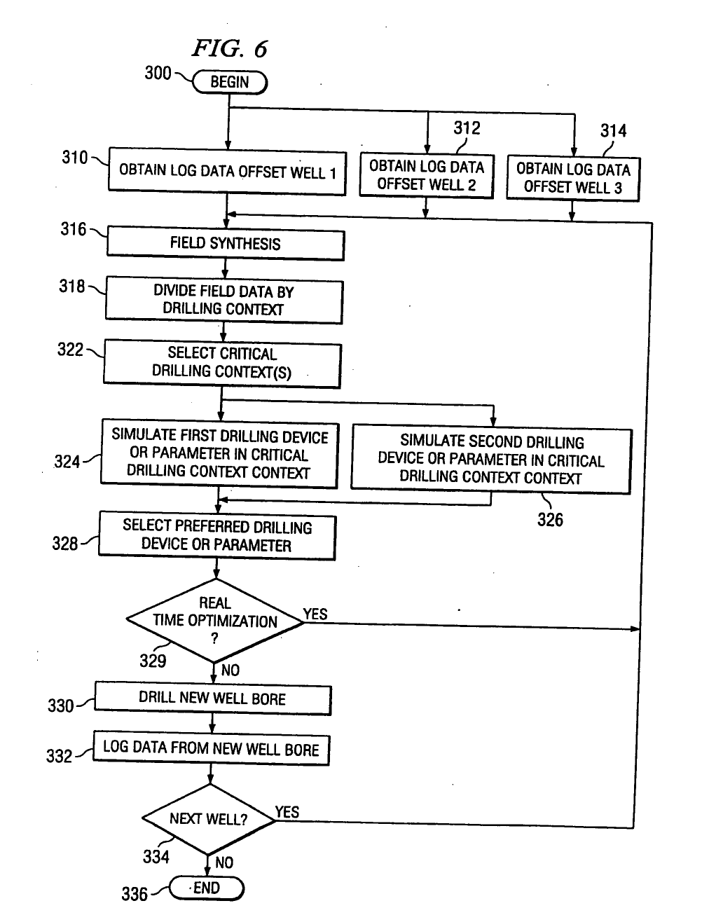

FIG. 6 is a flow chart showing a method, beginning at step 300 for synthesizing data from multiple offset wells to optimize drilling device and drilling parameters for a selected well. Initially, log data is obtained from at least three offset wells 310, 312, and 314. In alternate and subsequent embodiments, data from additional wells may preferably be considered. The offset log data is then preferably synthesized 316, as described above. Next the synthesized field data is divided into different drilling contexts for analysis 318. The different drilling contexts are then analyzed and the critical drilling context (or contexts) is selected 322.

After the selection of one or more critical drilling context, simulations 324 and 326 are performed for a selected different drilling devices or drilling parameters are run for the critical drilling context(s) of the offset wells. Additional simulations (for instance, for additional drilling devices or drilling parameters) may be also be run. The simulated drilling performance is then analyzed to select an optimized drilling device or drilling parameters 328. Following selection of an optimized drilling device it is determined whether the drilling performance of the new wellbore is to optimized in real time. If so, then during the drilling of the new wellbore, the actual drilling performance may be compared with the predicted drilling performance of the new wellbore. If the actual drilling performance deviates significantly (in a negative manner) from the predicted performance, the evaluation and selection of drilling contexts may be reconsidered. This may include incorporating drilling data that is obtained in real time or substantially in real time during the drilling of the new wellbore (as in steps 300 and 332 below) into field synthesis and using the newly obtained data to perform a new iteration of the present method.

If real time optimization is declined, the wellbore is drilled 330 and appropriate log data is collected 332. If additional wells are to be drilled in the field 334, the log data is included with the existing log data 310, 312, and 314 to update and optimize drilling device and drilling parameter selection for the new well. Otherwise, the method concludes 336.

FIG. 7 shows a graphical comparison 400 of multiple drill bits within a geologic context of rock strength from 15-40 Kpsi. The present example analysis shows the rate of penetration ratio for a nine blade fixed cutter drill bit 402, a seven-blade fixed cutter drill bit 404, and a six blade fixed cutter drill bit 406 as compared with an eight blade fixed cutter drill bit. As shown in the present example embodiment, in each well 408 shown six blade bit 406 is predicted to have a higher penetration rate compared with the seven blade bit 404. Seven blade bit 404, in turn, performs superior to nine blade bit 402.

FIG. 8 shows a graphical representation 420 of WOB and RPM values for the 15-40 Kpsi context, that were used in drilling wells 408. As shown, in the actual drilling of wells 408, the values of WOB 422 and RPM 424 were not constant in the drilling of the wells.

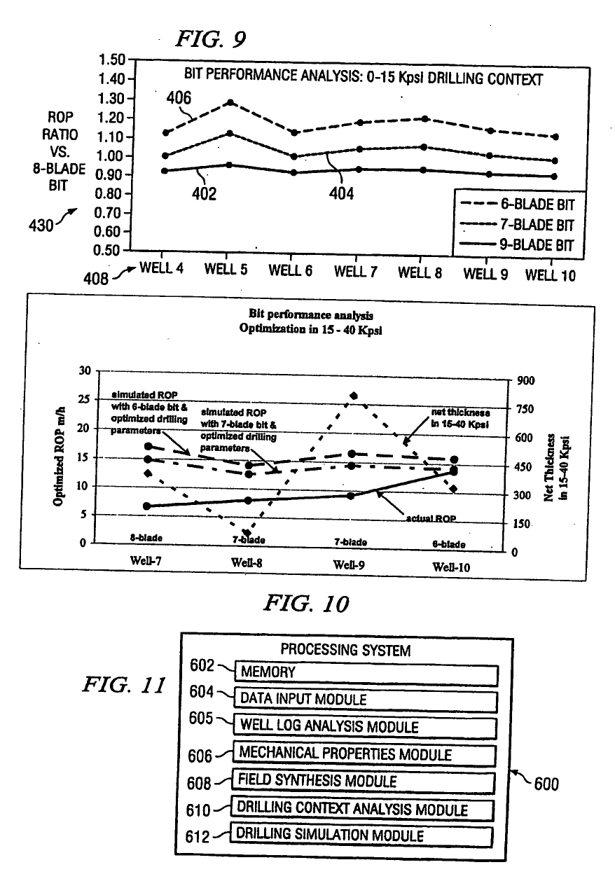

FIG. 9 shows a graphical comparison 430 of multiple drill bits within a geologic context of rock strength from 0-15 Kpsi. The present example analysis shows the rate of penetration ratio for a nine blade fixed cutter drill bit 402, a seven-blade fixed cutter drill bit 404, and a six blade fixed cutter drill bit 406 as compared with an eight blade fixed cutter drill bit. As shown in this example embodiment (and similar to the embodiment of FIG. 7), in each well 408 shown the six blade bit 406 is predicted to have a higher penetration rate compared with the seven blade bit 404. Additionally, the seven blade bit 404 is predicted to perform superior to nine blade bit 402.

FIG. 10 is a graphical representation 500 of an example field optimization. Graph 500 shows the net thickness 510 of the selected critical context—in this example, the portion of each well having a rock strength of 15-40 Kpsi. Graph 500 also shows the optimized, predicted performance for a six-blade fixed cutter drill bit 514 and a seven blade fixed cutter drill bit 516 as well as the actual performance 512 of each drill bit 518 that was use to drill each well 520. The first well shown (well 5) was drilled with an eight blade bit. Well 6 and Well 7 were subsequently drilled with a seven blade bit at which time the gap between the actual drilling performance 512 and the optimized drilling performance for either the seven blade bit 514 or the six blade bit 516 is reduced. This performance gap is further reduced when Well 8 is drilled with a six blade bit. As demonstrated, the field synthesis method for optimizing drilling operations give a much faster and steeper learning curve than existing methods.

FIG. 11 is a processing system 600 for optimizing the performance of a drilling device for drilling a selected well bore. Processing system 600 includes memory 602 which may be used to store log data or other lithology data from offset wells received by data input module 604. Processing system 600 also includes well log analysis module 605, mechanical properties assessment module 606, field synthesis module 608, drilling context analysis module 610, and drilling simulation module 612. Well log analysis 605 processes the well log data. Mechanical properties assessment module 606 acts to determine characteristics of the offset wells from the received offset well data such as rock strength, abrasivity, shale plasticity. Field synthesis module 608 synthesizes the log data from multiple offset wells as described above.

Drilling context analysis module 610 divides offset wells into multiple drilling contexts to assist in identification of one or more critical drilling contexts. Simulation module 612 acts to simulate the performance of one or more selected drilling devices in the at least one selected drilling context.

Although the disclosed embodiments have been described in detail, it should be understood that various changes, substitutions and alterations can be made to the embodiments without departing from their spirit and scope.

1. A method for optimizing the performance of a drilling device for drilling a selected well bore comprising:
obtaining well logs and drilling data from at least three offset wells associated with the selected well bore;
synthesizing the well logs and drilling data from the at least three offset wells;
evaluating the synthesized field data in a plurality of drilling contexts;
selecting at least one drilling context for predicting drilling performance; and
simulating the performance of a drilling device in the at least one selected drilling context.

2. The method of claim 1 wherein the drilling device comprises a drill bit.

3. The method of claim 2 further comprising:
simulating the performance of a first drill bit in a selected drilling context;
simulating the performance of a second drill bit in the selected drilling context; and
comparing the simulated performance of the first drill bit and the simulated performance of the second drill bit in the selected drilling context.

4. The method of claim 3 further comprising:
simulating the performance of a plurality of drill bits in the selected drilling context; and
comparing the simulated performances of the plurality of drill bits in the selected drilling context.

5. The method of claim 2 further comprising:
simulating the performance of a first drill bit in a selected drilling context within the at least three offset wells;
modifying at least one design parameter of the first drill bit; and
simulating the performance of the modified drill bit in the selected drilling context within the at least three offset wells.

6. The method of claim 5 further comprising the at least one design parameter selected from the group consisting of: number of blades, cutter type, bit profile, sharp slope, dull slope, friction slope, wear exponent, max work, initial contact area, and final contact area.

7. The method of claim 1 further comprising processing the well logs and drilling data to determine rock strength data.

8. The method of claim 7 wherein the selected drilling context comprises a selected rock strength interval.

9. The method of claim 1 further comprising processing the well logs and drilling data to determine plasticity data.

10. The method of claim 9 wherein the selected drilling context comprises a selected plasticity interval.

11. The method of claim 1 further comprising processing the well logs and drilling data to determine abrasivity data.

12. The method of claim 8 wherein the selected drilling context comprises a selected abrasivity interval.

13. The method of claim 1 wherein the well logs and drilling data comprises a plurality of formation types.

14. The method of claim 13 wherein the selected drilling context comprises a selected formation type.

15. The method of claim 1 wherein synthesizing the well logs and drilling data further comprises identifying at least one field trend.

16. The method of claim 15 wherein the at least one field trend further comprises variations in lithology.

17. The method of claim 15 wherein the at least one field trend further comprises variations in mechanical properties.

18. The method of claim 15 wherein the at least one field trend comprises variations in depth of formation

19. The method of claim 15 wherein the at least one field trend comprises variations in formation thickness.

20. The method of claim 1 further comprising:
simulating the performance of at least two drilling devices in the at least one selected drilling context of the at least three offset wells;
selecting a drilling device;
drilling the selected well bore using the selected drilling device;
obtaining lithology data of the drilled selected well bore; and
synthesizing the lithology data from the drilled selected well bore with the well logs and drilling data from the at least three offset wells to predict the drilling performances of a second selected well bore.

21. The method of claim 1 wherein synthesizing the well logs and drilling data further comprises selecting a critical drilling context for simulating drilling performance of the drilling device.

22. The method of claim 21 further comprising simulating the performance of the drilling device in the critical drilling context of the at least three offset wells.

23. The method of claim 21 further comprising:
initiating drilling of the selected wellbore using a selected drilling device;
obtaining well logs and drilling data from the drilling of the selected wellbore in real time;
synthesizing the newly obtained well log data and drilling data with the well log data and drilling data from the at least three offset wells; and
selecting at least one modified drilling context for predicting drilling performance; and
simulating the performance of a drilling device in the at least one modified drilling context.

24. A method for optimizing at least one drilling parameter to drill a selected well bore with a selected drilling device comprising:
obtaining well logs and drilling data from at least three offset wells associated with the selected well bore;
synthesizing the well logs and drilling data from the at least three offset wells;
evaluating the synthesized data in a plurality of drilling contexts;
selecting at least one drilling context for predicting drilling performance; and
simulating the performance of the drilling device in at least one selected drilling context in the at least three offset wells using a first drilling parameter value;
simulating the performance of the drilling device in the at least one selected drilling context in the at least three offset wells using a second drilling parameter value; and
comparing the simulated performance of the drilling device using the first drilling parameter and using the second drilling parameter.

25. The method of claim 24 wherein the first drilling parameter value and the second drilling parameter value comprise a first weight on bit value and a second weight on bit value.

26. The method of claim 24 wherein the first drilling parameter value and the second drilling parameter comprises a first revolutions per minute (rpm) value and a second rpm value.

27. The method of claim 24 further comprising processing the well logs and drilling data to obtain rock strength data.

28. The method of claim 27 wherein the selected drilling context comprises a selected rock strength interval.

29. The method of claim 24 further comprising processing the well logs and drilling data to obtain plasticity data.

30. The method of claim 29 wherein the selected drilling context comprises a selected plasticity interval.

31. The method of claim 24 further comprising processing the well logs and drilling data to obtain abrasivitiy data.

32. The method of claim 31 wherein the selected drilling context comprises an abrasivity interval.

33. The method of claim 24 wherein the selected drilling context comprises a selected formation type.

34. The method of claim 24 wherein synthesizing the well logs and drilling data further comprises identifying at least one field trend.

35. The method of claim 34 wherein the at least one field trend further comprises variations in lithology.

36. The method of claim 34 wherein the at least one field trend further comprises variations in mechanical properties.

37. The method of claim 34 wherein the at least one field trend comprises variations in depth of formation

38. The method of claim 34 wherein the at least one field trend comprises variations in formation thickness.

39. The method of claim 24 further comprising:
simulating the performance of a drilling device using the at least two drilling parameters in the at least one selected drilling context;
selecting a drilling parameter;
drilling the selected well bore using the selected drilling parameter;
obtaining well logs and drilling data of the drilled selected well bore; and
synthesizing the well logs and drilling data from the drilled wellbore and the well logs and drilling data from the at least three offset wells.

40. The method of claim 24 wherein synthesizing the lithology data further comprises selecting a critical drilling context for simulating drilling performance of the drilling device.

41. The method of claim 40 further comprising simulating the performance of the selected drilling device at the selected utilizing the selected drilling parameters in the critical drilling context of the at least three offset wells.

42. The method of claim 24 further comprising:
initiating drilling of the selected wellbore using the selected drilling parameters;
obtaining well logs and drilling data from the drilling of the selected wellbore in real time;
synthesizing the newly obtained well log data and drilling data with the well log data and drilling data from the at least three offset wells; and
selecting at least one modified drilling context for predicting drilling performance; and
simulating the performance of using the selected drilling parameters and modified drilling parameters in the at least one modified drilling context.

43. A system for optimizing the performance of a drilling device for drilling a selected well bore comprising:
an input module operable to receive well logs and drilling data from at least three offset wells associated with the selected well bore;
a field synthesis module operable to synthesize the well logs and drilling data from the at least three offset wells;
a context analysis module operable to divide the synthesized field data into a plurality of selected drilling contexts; and
a simulation module operable to simulate the performance of the drilling device in the at least three offset wells in the at least one selected drilling context.

44. The system of claim 43 wherein the input module further comprises:
a well log analysis module operable to process the well log; and
a mechanical properties module operable to determine the mechanical properties of the at least three offset wells.

45. The system of claim 42 further comprising the simulation module operable to simulate the performance of the drilling device in the at least three offset wells in a selected critical drilling context.

46. A method for optimizing the performance of a drilling device, substantially as hereinbefore described with reference to the accompanying drawings.

47. A system for optimizing the performance of a drilling device, substantially as hereinbefore described with reference to the accompanying drawings.
